(19) United States
(12) Patent Application Publication
(10) Pub. No.: US 2008/0170702 A1
(43) Pub. Date: Jul. 17, 2008

(54) METHOD FOR PERFORMING HANDOVER BETWEEN COMMUNICATION SYSTEMS

(75) Inventors: Shijun LI, Shenzhen (CN); Yongli JIA, Shenzhen (CN); Jie LI, Shenzhen (CN); Hailei WANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/032,244

(22) Filed: Feb. 15, 2008

Related U.S. Application Data
(63) Continuation of application No. PCT/CN2006/001850, filed on Jul. 26, 2006.

(30) Foreign Application Priority Data
Aug. 19, 2005 (CN) 200510090918.0

(51) Int. Cl. H04L 9/08; H04L 9/28

(52) U.S. Cl. 380/283; 380/28

(57) ABSTRACT

A method for determining an encryption algorithm includes: determining whether an encryption algorithm of a target communication system is received when a handover is initiated by a user terminal; acquiring an encryption algorithm corresponding to the target communication system according to predefined relationships between target communication systems and encryption algorithms when the encryption algorithm of the target communication system is not received; sending the acquired encryption algorithm to the user terminal. By applying the method of the present invention, the success rate of the handovers between systems increases.

### CROSS-REFERENCE TO RELATED APPLICATIONS

This application is a continuation of International Patent Application No. PCT/CN2006/001850, filed Jul. 26, 2006, which claims priority to Chinese Patent Application No. 2005100909180.0, filed Aug. 19, 2005, both of which are hereby incorporated by reference

### FIELD OF THE TECHNOLOGY

The present invention relates to technologies of call handover in communication networks, and more particularly, to a method for a user terminal to perform a handover between a third Generation (3G) communication system and a second Generation (2G) communication system.

### BACKGROUND OF THE INVENTION

In existing communication systems, 2G and 3G communication systems can coexist. Because of the mobility of a user terminal, it is possible for the user terminal to traverse two communication systems in the process of a call. For the purpose of ensuring that the conversation is not interrupted when the user terminal traverses different communication systems, it is necessary to perform a handover between 2G and 3G communication systems.

At the beginning of the handover, a serving Radio Network Subsystem (RNS-A) of the user terminal sends an Iu-Relocation-Required message to a serving Mobile Switching Center (MSC-A), indicating that the user terminal initiates a handover. The serving MSC-A sends a handover request message to a target Base Station Subsystem (BSS-B) to request to handover to the communication system of the target BSS-B. After reserving radio resources, the target BSS-B sends a HANDOVER REQUEST ACK message to the serving MSC-A. Thereafter, the serving MSC-A sends a Relocation Command message to the serving RNS-A, and the serving RNS-A sends a Handover Command message to the user terminal. The handover between systems is implemented via the interaction between network elements such as the user terminal, the serving RNS-A, the serving MSC-A and the serving BSS-B.

Generally, in both a serving communication system and a target communication system, the security of identity information and the security of conversation contents are protected for the user by encryption. According to the encryption description of a handover process described in the 3GPP protocol 44.018, the Handover Command message carries a Cipher Mode Setting Information Element (Cipher Mode Setting IE) for indicating an encryption algorithm used by a User Equipment (UE) when the UE hands over to the target cell. If the Cipher Mode Setting IE is not carried in the Handover Command message, it shows that the encryption algorithm used in the serving cell is still used after the handover procedure; if the Cipher Mode Setting IE is carried in the Handover Command message, it shows that the encryption algorithm indicated by the Cipher Mode Setting IE is used after the handover procedure. The Cipher Mode Setting IE may indicate the algorithm used in the serving cell or indicate that no encryption is needed.

Further, during a handover from the 3G communication system to the 2G communication system, if a 3G_MSC starts encryption, the Relocation Command message sent by the 3G_MSC needs to carry a Cipher Mode Setting IE for indicating the encryption algorithm used when the UE hands over to a GSM cell. If the Cipher Mode Setting IE is not carried, it shows that the original encryption algorithm is used. Because the encryption algorithms of the 3G communication system and those of the 2G network system are different, the Relocation Command message needs to carry the Cipher Mode Setting IE for indicating that the encryption algorithm of the 2G communication system is used after the handover.

In addition, when 2G_MSCs are not upgraded, the manners of sending the HANDOVER REQUEST ACK message by 2G Base Station Controllers (BSCs) produced by various vendors are different. For example, some 2G_BSCs, the Cipher Mode Setting IE is carried in a Handover Command of a Layer 3 message, and the Layer 3 message is packed in the HANDOVER REQUEST ACK message. For another 2G_BSCs, no Cipher Mode Setting IE is carried in the Handover Command. Instead, a Selected Encryption Algorithm is carried outside the Layer 3 of the HANDOVER REQUEST ACK message for indicating the 3G_MSC the encryption algorithm selected by the 2G_BSC. For yet another 2G_BSCs, there is no encryption information carried in the Handover Command or outside the Layer 3 of the HANDOVER REQUEST ACK message. In the third case, following problems occur.

The Relocation Command message is generated according to the Handover Command of the Layer 3 message packed in the HANDOVER REQUEST ACK message. Therefore, if the Handover Command does not carry the Cipher Mode Setting IE, the Relocation Command message sent to the UE does not carry the Cipher Mode Setting IE either. As a result, the UE can not acquire the encryption information of the target communication system after the handover, so that the handover fails.

Therefore, when a user terminal is to hand over between systems in accordance with the conventional method, the handover may fail because of the differences between encryption manners supported by the 3G communication system and those supported by the 2G communication system.

### SUMMARY OF THE INVENTION

The present invention provides a method for performing a handover between systems to ensure that a user terminal successfully performs a handover from a serving communication system to a target communication system.

A method for determining an encryption algorithm includes: whether an encryption algorithm of a target communication system is received is determined when a handover is initiated by a user terminal; an encryption algorithm corresponding to the target communication system is acquired according to predefined relationships between target communication systems and encryption algorithms when the encryption algorithm of the target communication system is not received; and the acquired encryption algorithm is sent to the user terminal.

An apparatus for acquiring an encryption algorithm includes: a processor configured to implement a method, and the method includes: whether an encryption algorithm of a target communication system is received is determined when a handover is initiated by a user terminal; an encryption algorithm corresponding to the target communication system is acquired according to predefined relationships between target communication systems and encryption algorithms when the encryption algorithm of the target communication system is not received; the acquired encryption algorithm is sent to the user terminal.

A computer program product includes a first computer program code, which, when executed by a computer unit, will cause the computer unit to perform the steps of a central node according to the method for determining an encryption algorithm.

By applying the present invention, it is ensure that a user terminal may successfully perform a handover from a serving communication system to a target communication system. Specifically, advantages of the present invention are as follow.

In the present invention, if a target MSC/BSC decides to encrypt, the device of a serving communication system or that of a target communication system determines an encryption algorithm supported by the target MSC/BSC after the handover, and sends the determined encryption algorithm to a user terminal. Therefore, it is unnecessary for an operator to upgrade MSCs/BSCs of the existing 2G network, handover failure caused by differences between encryption algorithms of different systems is avoided, so that the success rate of the handovers between a 3G network system and a 2G network system improves, and the cost of implementation is low. Moreover, the device of the serving communication system or that of the target communication system may determine an optional IE supported by the target communication system according to a self-stored IE data table. Therefore, handover failure is avoids the reason of which are that the target communication systems are unable to support the optional IEs carried in the messages from the serving communication systems, and the success rate of the handovers further improves.

Because the methods in the embodiments of the present invention effectively ensure successful handovers between two networks, the conversations of users may not be interrupted because of the handover failure, so the satisfaction rate of the users effectively improves. Further, by applying the methods in the embodiments of the present invention, excellent resources of the existing 2G network are utilized adequately to provide the users with effective services at the beginning of establishing the 3G network, so the competitiveness of the 3G network improves.

### BRIEF DESCRIPTION OF THE DRAWINGS

Embodiments of the present invention are as follows described in detail with reference to the accompanying drawings so as to make the above characters and merits of the present invention more apparent for those skilled in the art, the accompanying drawings include:

FIG. 1 is a flowchart illustrating a method for performing a handover between systems in accordance with the present invention;

FIG. 2 is a flowchart illustrating a method for performing a handover from a UMTS system to a GSM system in accordance with an embodiment of the present invention;

FIG. 3 is a flowchart illustrating a method for a serving MSC-A to determine an encryption algorithm used after a handover in accordance with an embodiment of the present invention; and

FIG. 4 is a flowchart illustrating a method for performing a handover from a UMTS system to a GSM system in accordance with another embodiment of the present invention.

### DETAILED DESCRIPTION OF THE INVENTION

Embodiments of the present invention are now made to the following description taken in conjunction with the accompanying drawings.

The present invention provides a method for performing a handover between systems. In the method, a table of encryption algorithm information is preconfigured for storing the identity of a target MSC and an encryption algorithm selected by the target MSC/BSC. When a user terminal performs a handover from a serving communication system to a target communication system, if encryption algorithm information is not received by a serving MSC, a serving MSC server or a serving Radio Network Controller (RNC), and if an encryption algorithm is selected by the target MSC/BSC, the serving MSC/MSC Server or the serving RNC sends the encryption algorithm selected by the target MSC/BSC to a handover serving side according to the table of the encryption algorithm information.

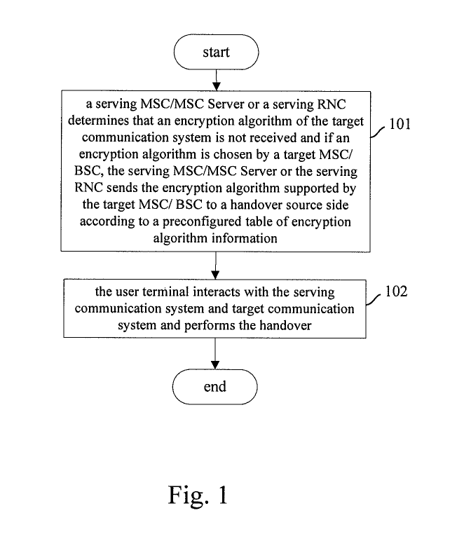

FIG. 1 is a flowchart illustrating a method for performing a handover between systems in accordance with the present invention. With reference to FIG. 1, the method is as follows.

At block 101, when a user terminal performs a handover from a serving communication system to a target communication system, if a serving MSC/MSC Server or a serving RNC determines that an encryption algorithm of the target communication system is not received and if an encryption algorithm is selected by a target MSC or BSC, the serving MSC/MSC Server or the serving RNC sends an encryption algorithm supported by the target MSC or BSC to a handover serving side according to a preconfigured table of encryption algorithm information.

At block 102, the user terminal interacts with the serving communication system and the target communication system, and performs the handover.

In the present invention, when the serving communication system is a 3G communication system, the target communication system may be a 2G communication system. Similarly, when the serving communication system is a 2G communication system, the target communication system may be a 3G communication system.

Two embodiments are given as follows to describe the method for performing the handover according to the present invention.

The embodiment I is described as follows.

In the embodiment, the serving communication system is a 3G communication system, the target communication system is a 2G communication system, and a table of encryption algorithm information is preconfigured in a device of the 3G communication system to ensure that a 3G user terminal successfully performs a handover between systems. The table of the encryption algorithm information includes identities of each MSC or BSC of the 2G communication system and flags. Each flag corresponds to the identities and indicates whether an encryption algorithm is selected. When the flag indicates that an encryption algorithm is selected, the table of the encryption algorithm information further includes the name of the selected encryption algorithm. In addition, a device in a UMTS system as the 3G communication system and a device in a GSM system as the 2G communication system belong to the same exchange in the embodiment.

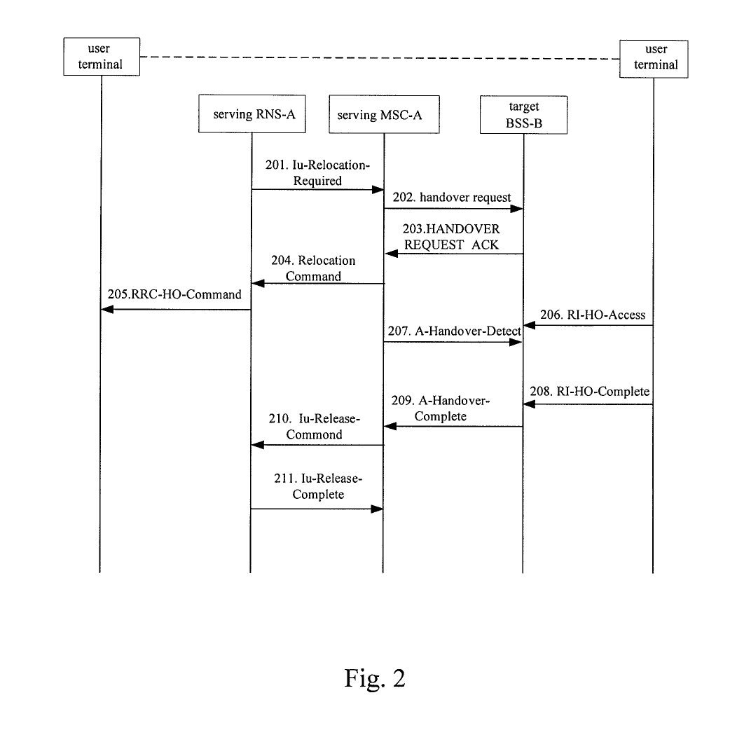

FIG. 2 is a flowchart illustrating a method for performing a handover between systems, and in the method, an MSC determines the encryption algorithm used after the handover. With reference to FIG. 2, the method is as follows.

Step 201: a user terminal performs a conversation in a 3G communication system. When the user terminal requests a handover, a RNS-A, via an Iu interface, sends an Iu-Relocation-Required message to a serving MSC-A in the 3G communication system to request the serving MSC-A to perform a handover, and the identity of a target cell is carried in the Iu-Relocation-Required message.

Step 202: after receiving the Iu-Relocation-Required message sent by the serving RNS-A, the serving MSC-A determines a target BSS-B according to the identity of the target cell, and sends to the target BSS-B a handover request message to notify the target BSS-B to reserve radio resources for the user terminal to be handed over.

Step 203: the target BSS-B reserves the radio resources and sends a HANDOVER REQUEST ACK message to the serving MSC-A.

Step 204: the serving MSC-A determines the encryption algorithm used after the handover, constructs a Relocation Command message, and sends the Relocation Command message to the serving RNS-A.

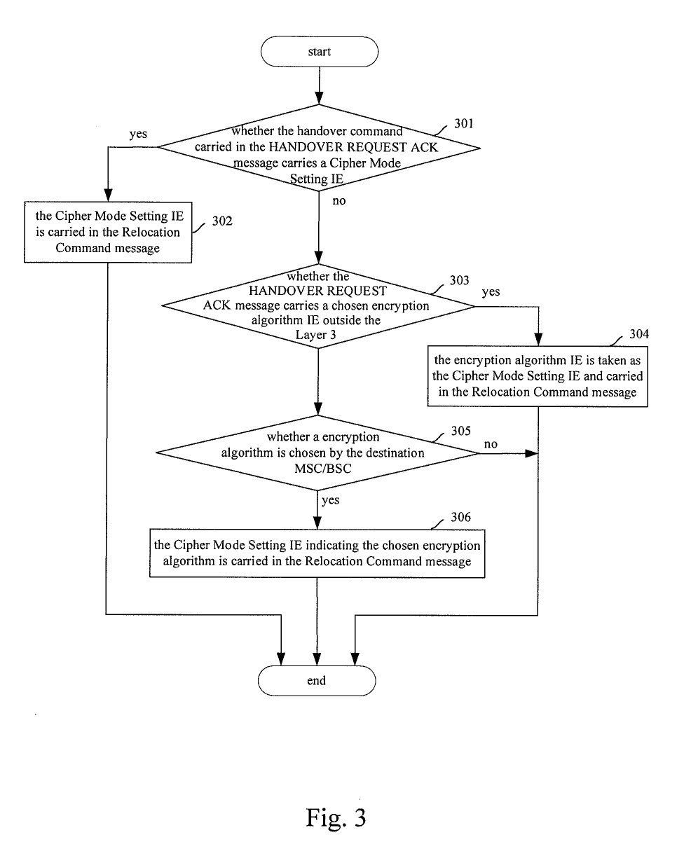

FIG. 3 is a flowchart illustrating a method for the serving MSC-A to determine the encryption algorithm to be used after the handover and to construct the Relocation Command message. The method specifically includes the following processes.

At blocks 301 and 302, after receiving the HANDOVER REQUEST ACK message sent by the target BSS-B, the serving MSC-A determines whether the Handover Command carried in the HANDOVER REQUEST ACK message carries a Cipher Mode Setting IE. If the Handover Command carries a Cipher Mode Setting IE, the Cipher Mode Setting IE is carried in the Relocation Command message, and the procedure for determining the encryption algorithm used after the handover is terminated; if the Handover Command carries no Cipher Mode Setting IE, block 303 is performed.

According to definitions in protocols, the HANDOVER REQUEST ACK message sent to the serving MSC-A by the target BSS-B carries a Handover Command in the Layer 3, so that the serving MSC-A may parse to obtain the Handover Command and send the Handover Command to a handover serving side, for example, the handover serving side may be the serving RNS-A. If the Handover Command carries a Cipher Mode Setting IE, it shows that the encryption algorithm used after the handover is designated by the target communication system, and the Cipher Mode Setting IE is sent.

At blocks 303 and 304, the serving MSC-A determines whether the HANDOVER REQUEST ACK message carries an encryption algorithm IE outside the Layer 3; if the HANDOVER REQUEST ACK message carries an encryption algorithm IE outside the Layer 3, the encryption algorithm IE is then carried in the Relocation Command message as the Cipher Mode Setting IE. And the procedure for determining the encryption algorithm used after the handover is terminated; if the HANDOVER REQUEST ACK message carries no encryption algorithm IE outside the Layer 3, block 305 is performed.

When the HANDOVER REQUEST ACK message carries the selected encryption algorithm outside the Layer 3, the value of the Cipher Mode Setting IE is the value converted from the selected encryption algorithm. For example, if the encryption algorithm indicated by the selected encryption algorithm is A5-1, the value of the Cipher Mode Setting IE is also A5-1.

At blocks 305 and 306, the serving MSC-A determines whether an encryption algorithm is selected by the target MSC/BSC according to a table of encryption algorithm information; if an encryption algorithm is selected by the target MSC/BSC, the name of the encryption algorithm selected by the target MSC/BSC is acquired from the table of the encryption algorithm information and carried in the Relocation Command message as the Cipher Mode Setting IE; if no encryption algorithm is selected by the target MSC/BSC, the procedure for determining the encryption algorithm used after the handover is terminated.

The serving MSC-A searches the table of the encryption algorithm information by taking the name of the target MSC/BSC as an index, determines whether an encryption algorithm is selected by the target MSC/BSC according to the corresponding flag indicating whether an encryption algorithm is selected, and the serving MSC-A acquires the name of the selected encryption algorithm if an encryption algorithm is selected.

According to blocks 301 to 306, when the serving MSC-A does not receive the information indicating the encryption algorithm used after the handover, the serving MSC-A determines the encryption information of the target MSC/BSC according to the table of the encryption algorithm information. When the target MSC/BSC selects an encryption algorithm, the serving MSC-A searches for the name of the encryption algorithm, and the name of the encryption algorithm is carried in the Relocation Command message sent to the handover serving side, so that the user terminal may use the encryption algorithm supported by the target communication system after the handover, and normal communication is performed. When the target MSC/BSC does not select an encryption algorithm, it shows that no encryption is needed, and no Cipher Mode Setting IE is to be carried in the Relocation Command message.

With reference to FIG. 2 again, after determining the encryption algorithm used after the handover and sending the constructed Relocation Command message to the serving RNS-A, the method for performing the handover between the systems in the embodiment is performed as follows.

Step 205: the serving RNS-A, via an air interface, sends an RRC-HO-Command message carrying the information of the encryption algorithm selected by the target MSC/BSC to the user terminal to notify the user terminal to handover from the serving RNS-A to the target BSS-B.

Steps 206 to 209: the user terminal, via the air interface, sends an RI-HO-Access message to the target BSS-B to indicate that the user terminal attempts to access the target BSS-B. The target BSS-B sends an A-Handover-Detect message to the serving MSC-A to indicate that the access of the user terminal is detected. The user terminal, via the air interface, sends an RI-HO-Complete message to indicate that the user terminal successfully accesses the target BSS-B. The target BSS-B sends an A-Handover-Complete message to the serving MSC-A to notify that the user terminal requesting the handover performs the handover successfully.

Steps 210 and 211: the serving MSC-A sends to the RNS-A an Iu-Release-Command message to notify the RNS-A to release the radio resources occupied by the original conversation.

After releasing the radio resources, the RNS-A sends an Iu-Release-Complete message to the serving MSC-A.

Thus, the handover from the 3G UMTS to the 2G GSM is successfully performed.

In the above procedure, the serving MSC-A stores the table of the encryption algorithm information and determines the encryption algorithm used after the handover. Alternatively, the entity storing the table of the encryption algorithm information and determining the encryption algorithm may also be a serving MSC Server of the serving communication system, and the handover process between the systems is the same as steps 201 to 211 and blocks 301 to 306.

In addition, a serving RNC may also store the table of the encryption algorithm information and determine the encryption algorithm used after the handover. In this way, at step 204, after receiving the HANDOVER REQUEST ACK message, the serving MSC-A sends the Relocation Command message to the serving RNS-A; and at step 205, the serving RNC of the serving RNS-A determines the encryption algorithm used after the handover and constructs the Handover Command message. The serving RNS-A sends the Handover Command message to the user terminal via the air interface to request the user terminal to handover from the serving RNS-A to the target BSS-B. The operation performed at the above step 205 is similar as that at blocks 301 to 306, and the difference is that, the entity performing the blocks is the serving RNC, and the Handover Command message is constructed according to the Relocation Command message.

Further, according to the definitions in the protocols, the handover request message not only carries mandatory IEs including the type of information, the type of the channel, encryption information, level label information 1 or level label information 2, a cell identifier and the target cell identifier, but also may carry optional IEs such as priority. For the purpose of avoiding that the optional IEs can not be identified by the target communication system, an IE data table may be predefined in the embodiment for storing the IEs of the handover request message supported by the target BSC. In this way, at step 202, the serving MSC/MSC Server searches the IE data table by taking the identity of the target BSC as an index, and the serving MSC/MSC Server determines the IEs supported by the target BSC, selects IE(s) from the determined IEs, and sends a handover request message carrying the IE(s) to the target BSC. In another solution, the IE data table may be stored in the serving RNC. In this way, at step 201, the serving RNC searches the IE data table to determine the IEs supported by the target BSC, selects IE(s) from the determined IEs, and sends an Iu-Relocation-Required message carrying the selected IE(s) to the serving MSC/MSC Server, and the serving MSC/MSC Server sends a handover request message carrying the selected IE to the target BSC. Therefore, the handover failure is avoided which is caused by that the IEs carried in the handover request message can not be identified by the target communication system. Therefore the success rate of the handover increases.

The embodiment II is described as follows.

Similar to the embodiment I, a table of encryption algorithm information is predefined in the embodiment for storing the identities of target MSCs/BSCs in the 2G communication system as the target communication system, flags corresponding to the identities and indicating whether an encryption algorithm is selected, and the name of the selected encryption algorithm. Different from the embodiment I, the device in the UMTS system as the 3G communication system and the device in the GSM system as the 2G communication system belong to different exchanges in the embodiment.

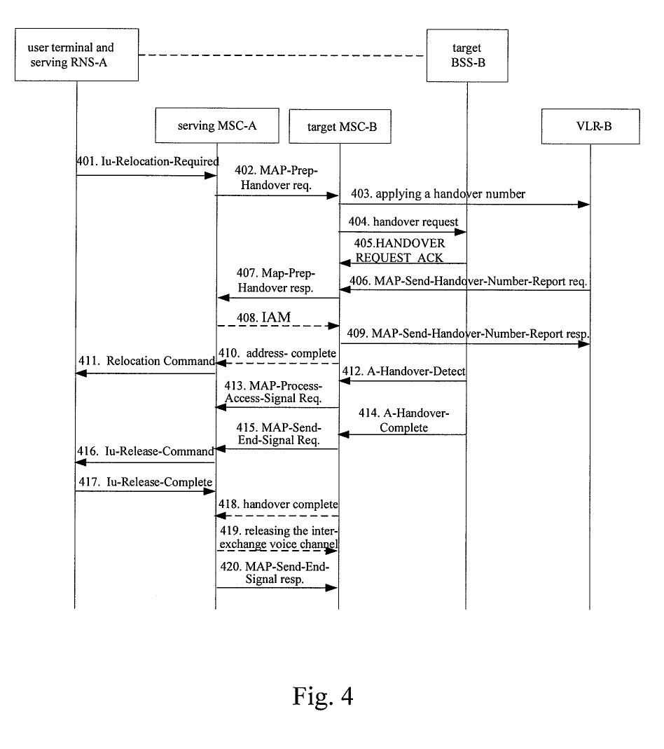

FIG. 4 is a flowchart illustrating a method for performing a handover between systems. In the embodiment, a serving MSC-A determines the encryption algorithm used after the handover. With reference to FIG. 4, the method is as follows.

Step 401: a user terminal performs a conversation in a 3G communication system. When the user requests a handover, an RNS-A, via an Iu interface, sends an Iu-Relocation-Required message to a serving MSC-A in the 3G communication system to request the serving MSC-A to perform a handover, and the identity of a target cell is carried in the relocation required message.

Step 402: the serving MSC-A determines a target BSS-B according to the identity of the target cell, and sends a prepare-handover request message to the target BSS-B, to notify the target BSS-B to reserve radio resources for the user terminal to be handed over.

Because it is an inter-exchange handover in the embodiment, the serving MSC-A first generates a 2G handover request message, and the serving MSC-A, on an E interface, packs the 2G handover request message to generate a MAP-Prep-Handover req. message, and sends the MAP-Prep-Handover req. message to the target MSC-B of the target BSC.

Similar to embodiment I, an IE data table may be predefined in embodiment □ for storing IEs of the handover request message supported by the target BSC. At this step, the serving MSC-A searches the IE data table by taking the identity of the target BSC as an index, determines the IEs supported by the target BSC, selects IE(s) from the determined IEs, and sends the MAP-Prep-Handover req. message carrying the IE(s) to the target MSC-B.

Steps 403 to 405: after receiving the MAP-Prep-Handover req. message, the target MSC-B requests a handover number from a Visit Location Register (VLR-B) to establish a voice channel between the serving MSC-A and the target MSC-B, i.e., preparing for Initial Address Message (IAM). The MSC-B sends a handover request message to the target BSS-B to request the target BSS-B to reserve radio resources for the user terminal requesting the handover. After reserving the radio resources, the target BSS-B sends a HANDOVER REQUEST ACK message to the target MSC-B.

Steps 406 and 407: the VLR-B sends to the target MSC-B a MAP-Send-Handover-Number-Report req. message carrying the handover number allocated by the VLR-B. The MSC-B, according to the received handover number allocated by the VLR-B and the HANDOVER REQUEST ACK message, constructs and sends a Map-Prep-Handover resp. message to the serving MSC-A to indicate that the radio resources and the handover number are ready.

Steps 408 to 411: the serving MSC-A analyzes the handover number sent by the target MSC-B, establishes the voice channel between the serving MSC-A and the target MSC-B, and sends the IAM to the MSC-B. The MSC-B sends to the VLR-B a MAP-Send-Handover-Number-Report resp. message to release the allocated handover number, so that the handover number may be allocated to other users requesting a handover. The MSC-B sends an address-complete message to the serving MSC-A to indicate that the voice channel between the serving MSC-A and the target MSC-B is established. Further, the serving MSC-A determines the encryption algorithm used after the handover, constructs and sends a Relocation Command message to the serving RNS-A to request the user terminal to handover from the serving RNS-A to the target BSS-B.

The procedure of blocks 301 to 306 shown in FIG. 3 may be used for determining the encryption algorithm used after the handover and constructing the Relocation Command message.

Steps 412 and 413: after the user terminal sends an RI-HO-Access message via the air interface, the target BSS-B sends an A-Handover-Detect message to the target MSC-B to notify the target MSC-B that the access of the user terminal is detected. The target MSC-B, via a MAP-Process-Access-Signal Req. message, sends the A-Handover-Detect message to the serving MSC-A to indicate that the user terminal prepares to access the 2G network.

Steps 414 to 417: after the user terminal accesses the 2G network, the target BSS-B sends an A-Handover-Complete message to the target MSC-B to notify the target MSC-B that the user terminal successfully accesses the 2G network. The MSC-B, via a MAP-Send-End-Signal Req. message sends the A-Handover-Complete message to the serving MSC-A to indicate that the user terminal successfully accesses the 2G network. Further, after receiving the MAP-Send-End-Signal Req. message, the serving MSC-A sends to the serving RNS-A an Iu-Release-Command message to notify the serving RNS-A to release the radio resources occupied by the original conversation. The serving RNS-A sends an Iu-Release-Complete message to notify the serving MSC-A that the radio resources occupied by the original conversation are released.

Steps 418 to 420: the MSC-B, via a relay interface, by using a message for example an ANSWER message, notifies the serving MSC-A that the handover is performed so as to keep the integrity of the relay signaling.

When the call ends, the serving MSC-A, via a RELEASE message, notifies the target MSC-B to release the inter-exchange voice channel. The serving MSC-A, via a MAP-Send-End-Signal resp. message notifies the target MSC-B to release the radio resources requested when the handover occurs.

Thus, the inter-exchange handover of the user terminal from the 3G UMTS system to the 2G GSM system is performed.

In this embodiment, the IE data table may also be predefined in the serving RNC. In this way, at step 401, the serving RNC searches the IE data table by taking the identity of the target BSC as an index, determines the IEs supported by the target BSC, selects IE(s) from the determined IEs, and sends an Iu-Relocation-Required message carrying the IE(s) to the serving MSC-A. The serving MSC-A sends the selected IE to the target MSC-B, and the target MSC-B sends a handover request message carrying the selected IE to the target BSS-B. In addition, the IE data table may also be predefined in the target MSC-B. In this way, at step 404, the target MSC-B searches the IE data table by taking the identity of the target BSC as an index, determines the IEs supported by the target BSC, selects IE(s) from the determined IEs, sends a handover request message carrying the selected IE(s) to the target BSS-B to request the target BSS-B to reserve radio resources for the user terminal requesting the handover.

The encryption algorithm used after the handover may be determined by the serving RNC in addition to the serving MSC-A. Specifically, when the table of the encryption algorithm information is predefined in the serving RNC, at the step 411, the serving MSC-A sends a Relocation Command message to the RNS-A to request the user terminal to handover from the serving RNS-A to the target BSS-B. The serving RNC of the RNS-A determines the encryption algorithm used after the handover and sends the determined encryption algorithm to the UE side. In this way, the serving RNC determines the encryption algorithm used after the handover according to the procedure similar to blocks 301 to 306 shown in FIG. 3, and the difference is that, the encryption algorithm used after the handover is determined by the RNC according to the Relocation Command message.

According to the above embodiments, the device of the serving communication system or that of the target communication system determines the encryption algorithm supported by the target MSC/BSC after the handover, and sends the determined encryption algorithm to the user terminal. Therefore, it is unnecessary for an operator to upgrade MSCs/BSCs of the existing 2G network, handover failure caused by differences between encryption algorithms of different systems is avoided, so that the success rate of the handovers between the 3G network system and the 2G network system increases, and the cost of implementation is low. Moreover, the device of the serving communication system or that of the target communication system may determine an optional IE supported by the target communication system according to a self-stored IE data table. Therefore, handover failure is avoided which are caused by that the target communication systems are unable to support the optional IEs carried in the messages from the serving communication systems, and the success rate of the handovers further increases.

Because the methods in the embodiments of the present invention effectively ensure successful handovers between two networks, the conversations of users may not be interrupted by the handover failure, so the satisfaction rate of the users effectively improves. Further, by applying the methods in the embodiments of the present invention, excellent resources of the existing 2G network are utilized adequately to provide the users with effective services at the beginning of establishing a 3G network, so the competitiveness of the 3G network improves.

The above are only preferred embodiments of the present invention and are not for use in limiting the protection scope of the present invention. All modifications, equivalent replacements or improvements made within the principles of the present invention should be covered under the protection scope of the present invention.

1. A method for determining an encryption algorithm, comprising:
determining whether an encryption algorithm of a target communication system is received when a handover is initiated by a user terminal;
acquiring an encryption algorithm corresponding to the target communication system according to predefined relationships between target communication systems and encryption algorithms when the encryption algorithm of the target communication system is not received; and
sending the acquired encryption algorithm to the user terminal.

2. The method of claim 1, wherein the relationships between target communication systems and encryption algorithms comprise:
relationships between encryption algorithms and identities of target Mobile Switching Centers (MSCs) or target Base Station Controllers (BSCs); and
the acquiring the encryption algorithm corresponding to the target communication system comprises:
acquiring the encryption algorithm corresponding to the target MSC or target BSC of the target communication system.

3. The method of claim 2, wherein the relationships between the target communication systems and the encryption algorithms further comprise flags, and each flag corresponds to a target MSC or BSC and indicates whether an encryption algorithm is selected; and
the encryption algorithm corresponding to the target MSC or BSC is acquired if the flag indicates that an encryption algorithm is selected.

4. The method of claim 1, comprising:
receiving, by a serving MSC or a serving MSC Server, a handover request ACK message from a target Base Station Subsystem (BSS);
determining that the encryption algorithm of the target communication system is not received when a handover command carried in the handover request ACK message carries no Cipher Mode Setting Information Element and the handover request ACK message carries no encryption algorithm Information Element; and
the sending the acquired encryption algorithm to the user terminal comprises:
sending, by the serving MSC or the serving MSC Server, a relocation command message carrying the acquired encryption algorithm to a serving Radio Network Subsystem (RNS); and
sending, by the serving RNS, the encryption algorithm to the user terminal.

5. The method of claim 1, comprising:
receiving, by a serving Radio Network Controller (RNC), a relocation command message from a serving MSC or a serving MSC Server;
determining that the encryption algorithm of the target communication system is not received when the relocation command message carries no Cipher Mode Setting Information Element and no encryption algorithm Information Element; and
the sending the acquired encryption algorithm to the user terminal comprises:
sending, by the serving RNC, a handover command message carrying the acquired encryption algorithm to the user terminal.

6. The method of claim 1, comprising:
receiving, by a serving MSC or a serving MSC Server, a response of a prepare-handover request message from a target MSC;
determining that the encryption algorithm of the target communication system is not received when a handover command carried in the response of the prepare-handover request message carries no Cipher Mode Setting Information Element and the response of the prepare-handover request message carries no encryption algorithm Information Element; and
the sending the acquired encryption algorithm to the user terminal comprises:
sending, by the serving MSC or the serving MSC Server, a relocation command message carrying the acquired encryption algorithm to a serving RNS; and
sending, by the serving RNS, the encryption algorithm to the user terminal.

7. The method of claim 1, further comprising:
determining Information Elements of a handover request message corresponding to a target BSC according to predefined relationships between target BSCs and Information Elements of the handover request message;
sending the handover request message carrying Information Element(s) to a target BSS; wherein the Information Element(s) is selected from the determined Information Elements of the handover request message.

8. The method of claim 7, wherein the Information Elements of the handover request message corresponding to the target BSC are determined by a serving MSC and the handover request message is sent by the serving MSC; or the Information Elements of the handover request message corresponding to the target BSC are determined by a serving MSC Server and the handover request message is sent by the serving MSC Server.

9. The method of claim 1, further comprising:
if the encryption algorithm of the target communication system is received, acquiring the received encryption algorithm.

10. The method of claim 9, comprising:
acquiring, by a serving MSC or a serving MSC Server, a Cipher Mode Setting Information Element, if a handover command carries the Cipher Mode Setting Information Element; wherein the handover command is carried in a handover request ACK message from a target BSS; and
the sending the acquired encryption algorithm to the user terminal comprises:
sending, by the serving MSC or the serving MSC Server, a relocation command message carrying the acquired Cipher Mode Setting Information Element to a serving RNS; and
sending, by the serving RNS, the Cipher Mode Setting Information Element to the user terminal.

11. The method of claim 9, comprising:
acquiring, by a serving MSC or a serving MSC Server, an encryption algorithm Information Element, if a handover request ACK message from a target BSS carries the encryption algorithm Information Element; and
the sending the acquired encryption algorithm to the user terminal comprises:
sending, by the serving MSC or the serving MSC Server, a relocation command message carrying the acquired encryption algorithm Information Element to a serving RNS; and
sending, by the serving RNS, the encryption algorithm Information Element to the user terminal.

12. The method of claim 9, comprising:
acquiring, by a serving RNC, an Cipher Mode Setting Information Element, if a relocation command message from a serving MSC or a serving MSC Server carries the Cipher Mode Setting Information Element; and
the sending the acquired encryption algorithm to the user terminal comprises:
sending, by the serving RNC, a handover command message carrying the acquired Cipher Mode Setting Information Element to the user terminal.

13. The method of claim 9, comprising:
acquiring, by a serving RNC, an encryption algorithm Information Element, if a relocation command message from a serving MSC or a serving MSC Server carries the encryption algorithm Information Element; and
the sending the acquired encryption algorithm to the user terminal comprises:
sending, by the serving RNC, a handover command message carrying the acquired encryption algorithm Information Element to the user terminal.

14. The method of claim 9, comprising:
acquiring, by a serving MSC or a serving MSC Server, an Cipher Mode Setting Information Element if a handover command carries the Cipher Mode Setting Information Element; wherein the handover command is carried in a response of a prepare-handover request message from a target MSC; and
the sending the acquired encryption algorithm to the user terminal comprises:
sending, by the serving MSC or the serving MSC Server, a relocation command message carrying the acquired Cipher Mode Setting Information Element to a serving RNS; and
sending, by the serving RNS, the Cipher Mode Setting Information Element to the user terminal.

15. The method of claim 9, comprising:
acquiring, by a serving MSC or a serving MSC Server, an encryption algorithm Information Element if a response of a prepare-handover request message from a target MSC carries the encryption algorithm Information Element; and
the sending the acquired encryption algorithm to the user terminal comprises:
sending, by the serving MSC or the serving MSC Server, a relocation command message carrying the acquired encryption algorithm Information Element to a serving RNS; and
sending, by the serving RNS, the encryption algorithm Information Element to the user terminal.

16. An apparatus for acquiring an encryption algorithm, comprising:
a processor configured to implement a method comprising:
determining whether an encryption algorithm of a target communication system is received when a handover is initiated by a user terminal;
acquiring an encryption algorithm corresponding to the target communication system according to predefined relationships between target communication systems and encryption algorithms when the encryption algorithm of the target communication system is not received; and
sending the acquired encryption algorithm to the user terminal.

17. The apparatus of claim 16, the method further comprising:
if the encryption algorithm of the target communication system is received, acquiring the received encryption algorithm.

18. The apparatus of claim 16, the method further comprising:
determining Information Elements of a handover request message corresponding to a target Base Station Controller (BSC) according to predefined relationships between target BSCs and Information Elements of the handover request message;
sending the handover request message carrying Information Element(s) to a target Base Station Subsystem (BSS); wherein the Information Element(s) is selected from the determined Information Elements of the handover request message.

19. A computer program product including thereon computer program code executable by a computer unit to perform the steps of a central node according to claim 1.

20. A computer program product including thereon computer program code executable by a computer unit to perform the steps of a central node according to claim 2.
